(19) United States
(12) Patent Application Publication
(10) Pub. No.: US 2004/0243485 A1
(43) Pub. Date: Dec. 2, 2004

(54) Method and system for providing product catalog information for electronic stores

(75) Inventors: Howard Borenstein, Downsview (CA); Victor S. Chan, Thornhill (CA); Robert M.H. Dunn, Toronto (CA); Aalim Lakhani, Toronto (CA); Lev Mirlas, Thornhill (CA); Tony C.K. Woo, Newmarket (CA)

Correspondence Address: John D. Flynn, IBM Corporation, Dept. T81/Bldg. 503, PO Box 12195, Research Triangle Park, NC, 27709, US

(73) Assignee: International Business Machines Corporation, Armonk, NY (US)

(21) Appl. No.: 10/785,839

(22) Filed: Feb. 24, 2004

(30) Foreign Application Priority Data
Jun. 2, 2003 (CA) 2,430,801

(51) Int. Cl. G06F 17/60

(52) U.S. Cl. 705/27

(57) ABSTRACT

A method for providing catalog information for presentation to a user of an electronic store in an electronic commerce system including: storing first and second portions of the catalog information in the store and in a profile store, respectively, to share the second portion of the catalog information between the store and a second store; and storing path information defining a sequential relationship between the store and profile store for retrieving the catalog information for the store.

### CROSS REFERENCE TO RELATED APPLICATIONS

This Application claims priority under 35 U.S.C. § 119(a) to Canadian Patent Application No. 2430801 filed Jun. 2, 2003, which is hereby incorporated herein by reference in its entirety.

### TECHNICAL FIELD

This invention relates generally to electronic commerce, and more particularly to the storage and retrieval of product catalog information for presentation to users through on-line electronic stores.

### BACKGROUND INFORMATION

Few technologies have revolutionized business more than the advent of the Internet. Merchants all over the world have been quick to realize that the Internet's true value is not in people's ability to browse the World Wide Web (“Web”) or send e-mail, but rather, in the new opportunities it creates for enhancing business processes, reducing costs and increasing profits through electronic commerce (“e-commerce”). Thus, e-commerce not only includes on-line transactions, it also encompasses technology to redefine old business models in order to maximize customer value. In fact, some merchants are taking e-commerce to the next level. Not only, are they adjusting their business processes to align with new technologies, they are fundamentally changing their organizations to be completely customer service and customer-satisfaction focused. Customers can order products or services on-line, check availability of the products, and follow their orders through the entire production process.

E-commerce systems currently exist that allow a merchant to establish an “electronic store” for selling products to customers over a computer network such as the Internet. Merchants use computers to publish information about their products on one or more electronic Web pages (e.g., text and graphics displayable on a computer screen) and to elicit product orders from customers. Likewise, customers use computers to access information describing products and to communicate orders to a merchant. Moreover, with the increasing popularity and accessibility of the Internet, and particularly the Web, the number of merchants using and desiring to use the Web to market and sell products is growing rapidly.

Now, e-commerce is traditionally carried out over a network such as the Internet using an e-commerce server networked with purchasers and merchants. The e-commerce server provides substantially all of the functionality needed to establish the electronic store and carry out buying and selling over the Internet. This includes storing product catalog information provided by merchants, accepting requests for information from prospective purchasers, and accepting and processing orders. The electronic store typically includes a collection of Web pages which describe merchants' product offerings and which include on-line forms allowing customers to place orders. Customers use Web browsers installed on their personal computers to access the Web pages of these electronic stores to examine information about available products and to submit product orders.

The e-commerce server may be operated by a merchant or a service provider. For example, rather than operate their own e-commerce servers, smaller merchants typically purchase e-commerce services provided by a service provider (or host). In this case, the service provider owns and maintains the e-commerce server and distributes configuration, operation, and maintenance costs across the subscriber merchants to realize economies of scale. However, in so doing, the service provider usually enforces uniform standards for appearance and methods of doing business to reduce the amount of custom programming necessary in order to economically accommodate several different merchants. Thus, each merchant being served loses a substantial amount of control over the way it conducts business over the network. This restricts the merchant's marketing flexibility. For example, it may hinder the merchant's ability to target specific markets. On the other hand, the provider faces problems with respect to the Web page content (e.g., product descriptions, catalogs, etc.) it receives from merchants. The service provider may face high costs in acquiring, publishing, and maintaining a database of merchant content. Thus, one problem with current e-commerce systems, whether the e-commerce server is operated by a merchant or a service provider, is that a merchant's marketing flexibility is hindered by the often substantial cost of acquiring, publishing and maintaining merchant content.

For example, one problem encountered by merchants attempting to operate electronic stores is the tedious job of periodically adding or deleting categories of products and reorganizing products into different categories within their product catalogs. Many on-line catalogs presenting inventories of electronic stores use a top-down menu approach wherein an initial catalog page appearing on a customer's computer screen lists general product categories. If a user selects one of the general categories, another page appears on the computer screen presenting a narrower subordinate menu of product lines. Thus, a user navigates from high level menus to lower level menus, eventually reaching a page that describes an individual product. This type of menu navigation is popular on the Internet and on other networks, because it is easy for customers to understand, and allows customers to reach a particular product in a convenient and timely manner. However, top-down menu style catalogs are difficult to design and maintain. This is because each of the pages of such a catalog typically includes multiple hyperlinks, each hyperlink providing a precise reference to another page. As a result, a change to one page may require changes to many other pages, creating a complicated and tedious editing job. More specifically, to effectively use the Web for advertising and selling products, merchants must create and edit not only the categories and products presented on a page, but also the hyperlinks tying a set of Web pages together such that a user can navigate the pages conveniently. This process is tedious, time consuming, inefficient, and highly susceptible of introducing errors, especially when altering hyperlinks of a large set of Web pages.

The cost of maintaining an electronic store is thus affected by the tools used to update the Web pages comprising the store. Existing Web page development tools are often not well suited to the task of developing and managing the content of these stores as they often lack the required functionality and flexibility. These tools are often burdensome or require a high level of technical knowledge or both. To address this problem, existing methods of establishing electronic stores use template Web pages to automate the process. However, this solution is often inadequate as a merchant's inventory typically fluctuates greatly, and electronic product catalogs require frequent updating due to, for example, changes in marketing strategy, changes in product availability and price, the introduction of new products or product lines, upcoming promotions, or product discontinuances.

For example, one problem that is common to the marketing and sales of products whether through physical stores or on-line electronic stores is the inability to determine which categories of a product line, or product catalog, will sell well at a particular store location. The result is that a product that sells well at one location may have a poor sales record at another location, such as in another city or on an other side of town, or on a different Web site.

Two solutions to this problem, both involving manipulation of the product catalog or inventory assigned to a store, have been attempted. One solution is to establish a “superstore” in order to assure product availability by offering a very large product selection. These superstores may be physical or electronic. The superstore provides a larger base of products in order to give the illusion of providing one-stop shopping to customers. Superstores, however, do not optimize inventory or product catalog size. Moreover, due to their size, they can be difficult to maintain in an on-line environment. A second solution is to tailor product availability to target customers of a specific store and to move product in and out of stock rapidly at each location based on customer demand. Both solutions have had some success. The second method, typically called target marketing, improves inventory and product management by optimizing product catalog size while supplying targeted customers with the products they desire. This second method, however, has the disadvantage of making each store's product offering unique and hence having product offerings that are inconsistent between stores. Thus, both of these solutions effectively restrict marketing flexibility by requiring substantial product catalog maintenance.

A need therefore exists for a method and system for providing product catalog information for presentation to electronic store users that is both flexible and efficient. Accordingly, a solution that addresses, at least in part, the above and other problems is desired.

### SUMMARY

According to one aspect of the invention there is provided a method for providing catalog information for presentation to a user of a store in an electronic commerce system. The catalog information may be divided into portions each including information relating to various items, products, or product categories, for example. The method includes the following steps: storing first and second portions of the catalog information in the store and in a profile store, respectively, to share the second portion of the catalog information between the store and a second store; and, storing path information defining a sequential relationship between the store and profile store for retrieving the catalog information for the store.

In one embodiment, the method further includes the steps of receiving a request for the catalog information from the user of the store, determining from the path information in which profile store the second portion of the catalog information is stored, and, in response to the steps of receiving and determining, retrieving the catalog information to fulfill the request.

In one embodiment, the step of retrieving includes retrieving a union of the first and second portions of the catalog information sequentially from the store and the profile store.

In one embodiment, the first and second portions of the catalog information have respective access restrictions, including editing restrictions.

In one embodiment, the catalog information includes items and the items include products and product categories. In addition, the catalog information can include product pricing and product description information for the products and product categories.

In accordance with further aspects of the present invention there is provided an apparatus such as an e-commerce server system and a database management system, a method for adapting a database management system, as well as articles of manufacture such as a computer readable medium having program instructions recorded thereon for practicing the method of the invention.

Advantageously, the present invention allows for improvements in the efficiency and flexibility of providing content for presentation to users of electronic stores by sharing portions of that content between back-end profile stores and flexible front-end operational stores in accordance with a “storepath” that defines a sequential relationship between the operational and profile stores.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating an exemplary electronic commerce system in accordance with an embodiment of the invention;

FIG. 2 is a diagram illustrating the logical structure of a catalog in accordance with an embodiment of the invention;

FIG. 3 is a flow chart illustrating operations of modules within an electronic commerce server for providing commerce asset information, including product catalog information, in accordance with an embodiment of the invention;

FIG. 4 is a block diagram illustrating storepaths between an operational and profile stores in accordance with an embodiment of the invention; and

FIG. 5 is a block diagram illustrating a data processing system that can be used to implement any portions of hardware implementing the systems and methods of the present invention.

### DETAILED DESCRIPTION

The following detailed description of the embodiments of the present invention does not limit the implementation of the invention to any particular computer programming language. The present invention may be implemented in any computer programming language provided that the OS (Operating System) provides the facilities that may support the requirements of the present invention. One embodiment is implemented in the JAVA™ computer programming language (or other computer programming languages such as C or C++ in conjunction with JAVA™). (JAVA and all JAVA-based trademarks are the trademarks of Sun Microsystems Corporation.) Any limitations presented would be a result of a particular type of operating system or computer programming language and would not be a limitation of the present invention.

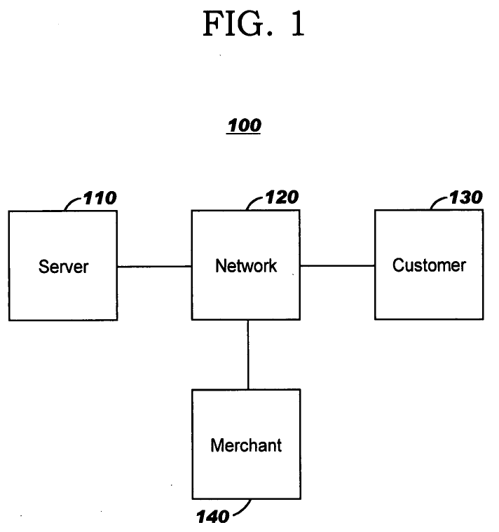

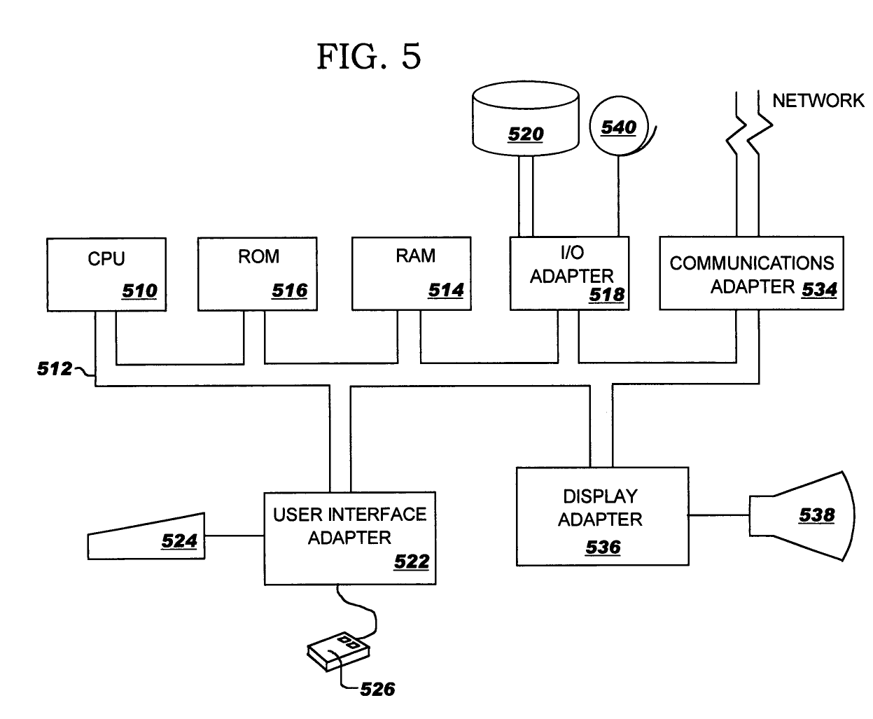

FIG. 1 is a block diagram illustrating an exemplary e-commerce system 100 in accordance with an embodiment of the invention. The e-commerce system 100 includes an e-commerce server system 110 communicating with merchant 140 and customer 130 systems over a network 120, such as the Internet. The e-commerce server system 110 includes a database system (not shown) for storing and accessing product catalog information for one or more merchants and provides transaction and content searching functionality. The merchant system 140 may be a server and may include the e-commerce server system 110. The server 110 is adapted to provide product catalog information in accordance with the present invention. The customer system 130 may be a personal computer with a Web browser for accessing the product catalog information presented by the server 110 over the network 120 as one or more Web pages. The system of FIG. 5 could be used to implement any of devices 110, 120, 130, 140.

Transaction functionality provided by the server 110 includes the capability to carry out actions needed to complete a purchase and sale over the network 120. For example, the server 110 may accept a credit card number from a customer and contact the credit card vendor to verify that the account has sufficient credit to complete the purchase of a product having a given price. Once authorization is received, the server 110 may send messages to a banking institution that debits the customer's account and credits that of the merchant, completing the purchase. Other transaction functionality may include: arranging to have the selected product shipped; and/or other order fulfillment functions, such as implementing a customer satisfaction survey along with product delivery, and storing the results for presentation and analysis.

The product catalog includes information pertaining to the products offered for sale by the merchant, including product names, manufacturers, colors, sizes, and prices. It may also include multimedia information concerning the product, including text, audio, graphic, animation and video data. The server 110 may also store data concerning merchants including warranty, guarantee, and merchandise return information, as well as background information regarding the merchant. In general, the product catalog is provided to the server 110 by the merchant who may update the product catalog at any time over the network 120.

The database system (not shown) includes a database management system (“DBMS”) and a database and is stored in the memory of the server 110. It will be appreciated that the database system may be shipped or installed without the database to or by end users. In general, the DBMS is adapted to read a query generated by the server 110 in response to a customer request for product catalog information submitted through a Web page. The DBMS then executes the query against the database and provides a query result to the server 110 for presentation to the customer. It will be appreciated that the database system may be stored in the memory of the server 110 or stored in a distributed data processing system (not shown).

An example of a suitable DBMS is the DB2™ Universal Database Management System product sold by IBM™. The DBMS is a software layer interposed between the actual database (i.e., the data as stored for use by the CPU of the server 110) and the users of the system. The DBMS is responsible for handling database transactions thus shielding users from the details of any specific computer hardware or database implementation. Using relational techniques, the DBMS stores, manipulates and retrieves data in the form of table-like relations typically defined by a set of columns or attributes of data types and a set of rows (i.e., records or tuples) of data. The standard database query language for dealing with relational databases implemented by most commercial DBMSs is the Structured Query Language (“SQL”).

The server 110 includes a central processing unit (“CPU”) (not shown) operatively coupled to memory which also stores an operating system (not shown) for general management of the system 110. An example of a suitable server system 110 is an IBM™ iSeries™ computer. The server 110 includes computer executable programmed instructions for directing the server 110 to implement the embodiments of the present invention. The programmed instructions may be embodied in one or more software modules resident on the server 110. Alternatively, the programmed instructions may be embodied on a computer readable medium (such as a CD disk or floppy disk) which may be used for transporting the programmed instructions to the memory of server 110. Alternatively, the programmed instructions may be embedded in a computer-readable, signal-bearing medium that is uploaded to a network by a vendor or supplier of the programmed instructions, and this signal-bearing medium may be downloaded to the server 110 from the network by end users or potential buyers.

The CPU of the server 110 is typically coupled to one or more devices (not shown) for receiving user or customer queries and for displaying the results of the queries to users over the network 120. User queries may be transformed into a combination of SQL commands for producing one or more tables of output data which may be incorporated in one or more Web pages for presentation to the user. The CPU is coupled to memory for containing programs and data such as base tables or virtual tables such as views or derived tables. The memory may include a variety of storage devices including internal memory and external mass storage typically arranged in a hierarchy of storage as understood to those skilled in the art.

As will also be understood by those skilled in the art, the e-commerce server 110 may include a number of separate servers depending on merchant requirements. For example, the e-commerce server 110 may include separate Web presentation, Web application, transaction, data, security, and edge servers.

As mentioned above, an important concept in e-commerce applications is that of the “store”. A store represents the virtual area where business is conducted on the Web. For example, a merchant may establish a store on the Internet where the customers may purchase or exchange goods or services. Frequently a single store is not enough to capture all of a merchant's marketing strategies. For example, a merchant may have many brands which target different market segments. There are, of course, other reasons for creating more than one store on a site including the following:

1. Market Research. An experimental store could be created by making small changes to an original store for testing a new cross-selling plan. Selected customers could be automatically rerouted to this experimental store in order to determine the plan's effectiveness; and,

2. Shared Resources. In a hosted business model, an e-commerce service provider could allow merchants to create their own stores. To make the management of the overall site feasible, many assets within these stores, such as web pages and business logic, could be shared.

Thus, it is frequently important to ensure that the stores on the site share the same infrastructure or commerce assets, such as presentation, business logic, catalog, fulfillment, etc. However, sometimes not all these characteristics can be shared. For example, while two stores may have many products in common, some products may only be available in one of the stores, some Web pages may also be distinct, etc., for other commerce assets.

By storing and accessing commerce assets (e.g., catalog information, presentation information, etc.) using a path infrastructure, which may be referred to as a “storepath”, the controlled sharing of selected commerce assets for a selected set of stores on a site may be facilitated. To control costs and improve efficiency, it is important that store specific and shared store assets share the same infrastructure, so that the same tools can be used to manage the shared and non-shared store assets. Advantageously, such a storepath infrastructure allows the merchant to decide whether a commerce asset is to be shared among stores at the time of site creation or dynamically after the site is created. This improves the flexibility of the merchant's marketing strategies.

A storepath is somewhat similar to a shell path within a UNIX™ operating system. UNIX is a trademark of The Software Foundation, Inc. That is to say, a store specifies that its commerce assets may be looked up along a specified path. However, there are several distinctions as follows:

1. The path does not list directories in the file system, rather, it lists other stores. Thus, a store's storepath instructs the server's runtime logic to look for commerce assets in the stores listed in the storepath, in the order indicated.

2. Several storepaths may be defined for each store, one for each type of commerce asset.

3. Several stores may be listed in the storepath for each store asset and a precedence for the stores can be set.

If a store's storepath references another store, then the latter store may be referred to as a “profile store” for the former store. The storepath and profile store concepts avoid some of the disadvantages of known solutions which include the following:

1. Grouping Stores. Grouping of stores has several disadvantages: a store usually belongs to only one store group; there is no distinction among store groups as to what resources or assets they support; and, there is no hierarchy of groups.

2. Explicitly Defining Relationships for Commerce Assets to Each Store. This solution is very laborious and hard to maintain because it requires management of large amounts of fine-grain data and business logic.

3. Different Tools. Different tools are required to manage resources defined in a store versus a store group. Unlike a store group, a profile store is simply a type of store. Any tools that are used to manage a store can be used to manage a profile store.

Thus, according to the present invention, storepaths and profile stores are created to support different types of commerce assets including: catalogs; information presentation logic; marketing information; business logic; business relationships; inventory item definitions; inventory tracking; prices; calculation methods; currency related information; unit of measure related information; and, language and locale related information.

In more detail, a storepath for a store SA is a sequence of typed directed relationships between the store (SA) and a set of related stores {SB1, SB2, SB3, . . . }, where the types of the relationships are all the same. If each relationship is represented as (SA, SB, RT, S), where SA represents store SA, SB represents one of the related stores, RT represents the relationship type, and S is a number that can be used to sequence relationships with the same type, then a storepath SP can be represented as (SA,RT,SB1,S1), (SA,RT,SB2,S2), . . . (SA,RT,SBn,Sn) where S1 <= S2 <= . . . <= Sn, and n represents the number of relationships in the storepath. Thus, the set of storepaths for all stores for all relationship types can be represented as a mapping MSP from store and relationship type to an ordered list of related stores:

MSP(SA,RT)->(SB1,SB2, . . . SB3)

Each commerce asset instance CA has an asset type AT and an associated store AS. Thus, the set of commerce assets of type AT for store AS can be represented as {(CA1,AT,AS), (CA2,AT,AS), . . . (CAn,AT,AS)}. Each store SA maps asset type AT to a relationship type RT. Thus the set of asset types for a storepath SP can be represented as {(AT1,RT,SA), (AT2,RT,SA), . . . (ATn,RT,SA)}. This mapping can be represented as:

MATRT(SA,AT)->RT

Now, a commerce asset is available to a store SA by way of storepath SP if it is associated with one of the related stores in storepath SP and its asset type AT is mapped by store SA to the relationship type RT of storepath SP. Thus an ordered list of commerce assets with asset type AT available to store SA by way of storepath SP can be represented as (CA1,SA,SBk1,AT,RT,S1), (CA2,SA,SBk2,AT,RT,S2), . . . (CAn,SA,SBkn,AT,RT,Sn), or more simply, by removing common information from each element, (CA1,SBk1,Sk1), (CA2,SBk2,Sk2), . . . (CAn,SBkn,Skm), where Sk1 <= Sk2 <= . . . <= Skm, and SBki is the associated store for commerce asset CAi, which is one of the related stores for store SA for relationship type RT. As the number of stores in a storepath is typically small (e.g., 2 or 3), and the number of stores, relationship types, and asset types is typically not large (e.g., less than ten thousand, one hundred, and one hundred, respectively), the mappings MSP and MATRT are small enough to be cached in the volatile memory of the server 110.

In addition, as there are typically large numbers of asset instances available to stores, the asset instances are typically stored in relational database tables (e.g., one table for each asset type) in the server's 110 database system. Given a store SA, and an asset type AT, two ways of accessing this database may be described as follows:

1. Single SQL Database Query. A single SQL database query can be constructed to obtain the ordered list. The query specifies the table T for the asset type AT, and the ordered list of related stores obtained by evaluating the cached composite mapping MSP(SA, MATRT(SA,AT)). An exemplary SQL query is “SELECT 1, CA, SB FROM T WHERE SB=B1 UNION 2, CA, SB WHERE SB=B2 . . . UNION n, CA, SB WHERE SB=Bn ORDER BY 1”.

2. Multiple SQL Database Queries. Multiple SQL database queries can be executed, one for each of the related stores obtained by evaluating the cached composite mapping MSP(SA, MATRT(SA,AT)), to obtain the ordered list.

Exemplary SQL queries are “SELECT CA, SB FROM T WHERE SB=Bi”, for i from 1 to n. The ordered list is obtained by appending each result to the ordered list as it is obtained.

Thus, the business logic of a store need not be aware of the existence of a storepath when retrieving commerce assets. It only needs to know the store SA and the asset type AT. The fact that several related stores may be involved in the search for the commerce assets is hidden from the main business logic of the store.

Different stores can often be very similar in look and feel or products sold and only have small differences in presentation (e.g., store trademarks, service marks, or other store indicia) or pricing. Advantageously, profile stores allow for all the common data to be stored in one location and thus avoid having to maintain the same data in many places. This improves efficiency. The profile store can store all the common data (e.g., JAVA Server Pages™ (“JSPs”) for presentation, catalog for products sold, etc.), each store can reference the profile store, and each store can store its store specific data (e.g., store logo, prices for products sold, etc.). Thus, profile stores simplify store creation and store management functions and improve marketing flexibility.

A profile store may model specific business practices (e.g., business to consumer (B2C) or business to business B2B) and define one or a set of commerce assets such as catalogs, prices and business processes. A profile store can be managed using server 110 based tools but, in general, it does not support shopping activities (e.g., a customer cannot shop in a profile store). An “operational store”, that is, a store that a customer can shop in, can look up a commerce asset from one or more profile stores for a specific asset type. The storepath concept is implemented by a software module or modules within the server 110 and by storepath tables within the server's database. The storepath tables may include, for example, the following columns: Store ID, Commerce Asset Type, and Alternate Store ID.

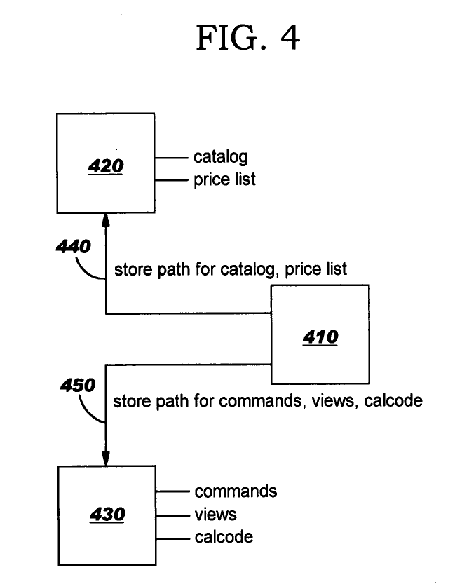

FIG. 4 is a block diagram illustrating storepaths 440, 450 between an operational store 410 and profile stores 420, 430 in accordance with an embodiment of the invention. The concepts of storepath and profile store enable the sharing of store resources such as configuration data and business processes between stores. In FIG. 4, the operational store 410 draws command, view, and calculation code (or “calcode”, see below) information from its associated profile store 430. In addition, catalog and pricelist information is drawn from a catalog profile store 420. Thus, the data path 450 from the operational store 410 to the profile store 430 represents a profile storepath and the data path 440 from the operational store 410 to the catalog profile store 420 represents a catalog profile storepath. It should be noted that both profile and operational stores share the same object model. There is no restriction that an operational store cannot be used in the storepath. To improve performance further, the storepaths may be stored in cache memory within the server 110. Thus, for each store 410, a different set of storepaths can be defined for different commerce assets used by the store.

As mentioned, a storepath-enabled electronic store may include information relating to the following commerce assets: catalog, presentation, marketing, business logic, business policies, inventory item, inventory tracking, price, and tax calculation. Advantageously, the present invention provides efficient and flexible operations for sharing these commerce assets, and in particular catalog assets, among multiple stores. These operations are described further herein below for respective commerce assets.

Catalog. Known solutions for sharing catalog assets between stores require references to the shared assets to be maintained in each store. As such, new additions to the catalog intended for many stores require an operation to add the asset change to each store. Advantageously, in accordance with the present invention, the storepath and profile store concepts are extended to the sharing of catalog assets among multiple stores.

In the following, the term “catalog” will refer to a collection of “products” or “product categories”. Product categories are organized in a hierarchical manner with products belonging to product categories. An “item” in a catalog may thus refer to a product or a product category. The term “product manager” will refer to a store administrator having the authority to update the catalog for that store. The term “current store” will refer to the store whose assets are being accessed, that is, the Web pages describing the store's products are either being viewed by a customer or they are being edited by a product manager. The term “catalog profile store” will refer to the store which contains catalog assets that are intended to be shared. The term “leaf store” (or operational store) will refer to the lowest level store in a store path relationship referencing a catalog profile store.

In accordance with the present invention, catalogs are shared among stores in accordance with the following catalog profile store, leaf store, profile store, and storepath semantics:

1. The shared catalog is defined for the profile store.

2. Items (i.e., products and product categories) can be either in a leaf store or in a profile store or stores but in the same catalog defined from the profile store. Items in the profile store are to be shared by all leaf stores of the profile store.

3. A customer in a leaf store may view or search all items defined in the leaf store in union with the items from the profile store, subject to a catalog filter.

4. When working with the catalog from a leaf store, a store administrator acting as a product manager may view or search items in the leaf store in addition to profile store items. The product manager may edit all items defined in the leaf store, but may not edit profile store items. Profile store items are read-only entities for the product manager of the leaf store.

5. A product manager for a leaf store may not view, search or edit items in another leaf store that is not in its storepath even though the catalog is shared from the profile store.

6. When working with the catalog from a catalog profile store, the product manager may view, search or edit items defined only in the profile store. Items from the leaf stores do not appear in the catalog profile store.

7. Merchandising associations (see below) presented for an item are the set defined in the current store in union with the set defined in the profile store(s).

8. A product manager for a leaf store may edit merchandising associations for the current store, but may not remove the merchandising associations presented by the profile store.

9. Item pricing may be overridden at the leaf store level or inherited from the profile store (e.g., to keep the MSRP set by the profile store).

Advantageously, the present invention enables a catalog to be shared amongst stores where the shared assets are placed in a profile store and updates are immediately applied to all stores who have the profile store in its storepath. Each leaf store can also add catalog items to the shared catalog but these will only be available to that specific store.

As mentioned, a store's catalog consists of all items (such as products and product categories) defined in the store, plus all items defined in the profile stores in its catalog storepath. However, a store administrator is responsible for the content of only those catalog entries defined in the administered store. Thus, a store administrator may add new items to the catalog for the administered store even though many of the items in the catalog are defined in a catalog profile store. New products may be added to any categories, and new categories may be added as well.

From the leaf store, new product categories can be created and added to the catalog by a product manager and these categories will only be visible in the leaf store. New items can be added to either the new categories or directly to existing categories provided by the profile store catalog. These products will also be only visible to the particular leaf store.

Another type of asset that may be defined in the catalog is a set of merchandising associations for the products and items. Examples of merchandising associations include up-sells and cross-sells. The merchandising association for a product are the union of all merchandising associations of that type defined in the store and all its profile stores in its catalog storepath. A store administrator is responsible for the content of merchandising associations defined in the administered store, but not those in its profile stores.

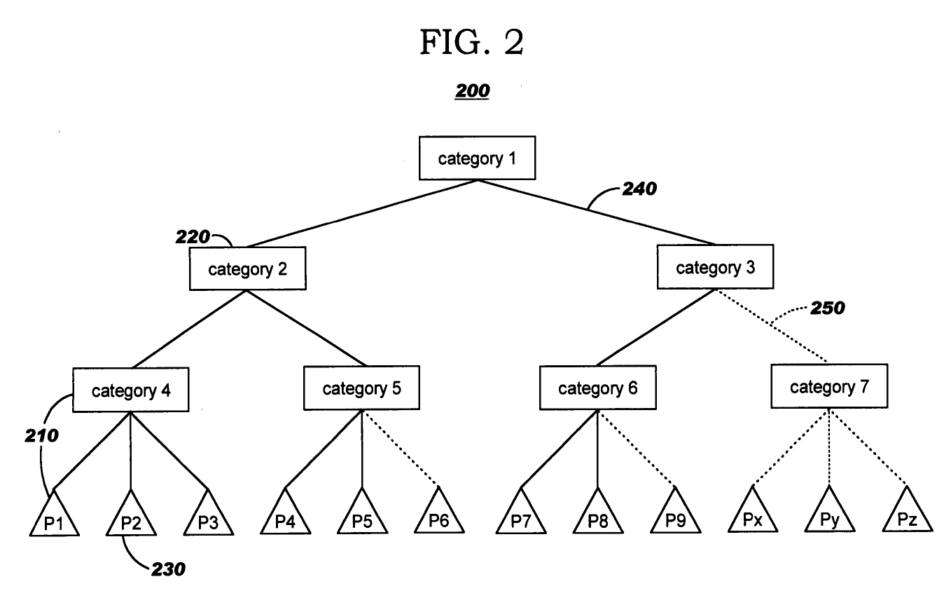

FIG. 2 is a diagram illustrating the logical structure of a catalog 200 in accordance with an embodiment of the invention. The catalog 200 includes items 210 that may be product categories 220 or products 230. In FIG. 2, the solid lines 240 represent the profile store catalog while the dashed lines 250 represent the categories and items only visible to the leaf store. The administrator of the profile store can view and edit categories 1 through 6 and items P1 through P5, P7, and P8. The product manager for the leaf store can view all products and categories but can only edit category 7 and products P6, P9, Px, Py, and Pz. The product manager for the leaf store can also create prices for all products.

Presentation. According to the present invention, all Web pages, encapsulated together with presentation logic are associated with views with each view having a unique name within a store. The term “view” is used here in the sense of the well-known model-view-controller design pattern. When the programming for a store requests a view by name, the store itself, and then the stores in its presentation storepath, are searched in sequence for a view with that name. The first such view found is used by the programming for the presentation of that view.

A store administrator is responsible for the content of the views defined in the administered store, but not for the content of those defined in its profile stores. Thus, in a service provider or hosting environment, a hosted store by default will share all the views via the presentation profile store. A store administrator can however upload a file (e.g., gif, JSP, etc.) and store it in the corresponding store directory. In this way, a store can easily change any default view, such as a store logo or welcoming page. The following example illustrates this effect:

| Item # | Store # | JSP Name |
|---|---|---|
| 10 | 100 | Item10.jsp |
| 10 | 101 | Item10_101.jsp |
| 11 | 100 | Item11.jsp |

In this example, assume that store 100 is the catalog profile store and store 101 is a leaf store. If item 10 is being accessed by a customer in the leaf store, the customer would see the result of the execution of the Item10_{—}101.jsp since the leaf store has a corresponding template for this item. However, if the customer accessed item 11, the customer would see the result of the execution of the profile store Item11.jsp, since the leaf store did not have a corresponding template.

Marketing. The marketing asset is used for presentation and scheduling of campaigns, such as upsells, cross-sells, discounts, and advertising. A store may define a set of marketing “spots” where campaign “initiatives” may be displayed. When a view containing such a spot is presented to a customer, the associated initiative is also shown. A scheduling process can also be included whereby an initiative is scheduled to be shown on a spot during certain times.

Spots available to be shown in a store are the union of all spots in the store and in all stores in its marketing storepath. Initiatives available to be shown in a store's marketing spots are the union of all initiatives in the store and in all stores in its marketing storepath. If several stores along the storepath define initiatives of the same name, then the initiative with that name found first in the storepath is shown. When a view containing a spot is shown for a store, one or more of the initiatives (according to the business logic of the store) scheduled for the store, and for the stores in its marketing storepath, are shown.

A store administrator is responsible for the content of the marketing spots and initiatives defined in the administered store, but not for the content of those defined in its marketing profile stores. A store administrator is responsible for the definition of schedules controlling when initiatives appear on a spot, but not for schedules defined in its marketing profile stores.

Business Logic. Business logic, as represented by the logic that corresponds to a URL, a function, or another term depending on the operating system and application platform, is encapsulated in a named “command interface”. Each store defines a set of named command interfaces that it supports, and associates each command interface with a programming implementation, such as a JAVABean™ class.

When a named command is invoked for a store, the command interface name is used to find its associated programming implementation by searching first in the store, and then, if not found, in the stores in its business logic storepath. The first found such programming implementation is the one executed for that command invocation.

A store business logic administrator is responsible for defining the business logic used by the administered store, but not for defining the business logic used by its profile stores. As a result, a business logic profile store can be created for each business model, and each can have its own implementation. This allows a single site/infrastructure to be created to host multiple business models. The business logic profile store allows stores to follow the same business rules to be shared but it also provides a way for the store to isolate itself from other business models and to have its own set of business rules.

Business Policies. A business policy is a set of rules followed by a store or group of stores defining business processes, industry practices, or the scope and characteristics of business offerings.

Business policies represent a common interface to a set of business process functions. For a particular business process, a common interface is defined for how to use and follow that business process. A store can then specify the use of a particular business process, or a particular customer of the store can be allowed to use one business process instead of another. If a store requires a different implementation of a business process, then they can use the common business process interface, but define their own implementation of the business process. Multiple stores can share a business process.

Inventory Item. Inventory item assets are different from catalog assets in that a catalog defines those aspects of products visible to customers, whereas inventory items define properties of products associated with the store's own backend processes, such as inventory tracking and fulfillment related properties of items.

A store may define various properties of inventory items, such as whether inventory is tracked for an item, whether it may be backordered, whether it is discontinued, whether it should be released to fulfillment separately from other items, etc.

When an item is purchased in a store, the store's programming must discover the inventory item properties for that item. If the store has defined inventory item properties for the item, then those properties are used. Otherwise, each store in the inventory item storepath is searched, in sequence, until the properties are discovered.

A special case is when the product purchased is a kit consisting of several items. Two treatments of this case are possible:

1. Properties for the kit are discovered by searching first in the store and then in the stores in the storepath, as described above. The store where the properties for the kit item are found is then used to find all items corresponding to all products in the kit, without regard to the storepath. Thus, properties for the entire kit, including its component items, will be obtained from a single store. If that store does not define properties for one or more items in the kit, then an error situation results, and the purchase is blocked for manual processing, or until the error condition is fixed, that is, all necessary items are defined in that store.

2. Properties for the kit, and for each component item in the kit, are discovered by searching first in the store and then in the stores in the storepath, as described above, once for the kit, and once for each component item. Thus, the properties for each component item may be discovered in different stores.

A store administrator is responsible for the content of the inventory item properties defined in the administered store, but not for the content of those defined in its profile stores.

Inventory Tracking. Counts of current and expected inventory are used by stores to determine if or when purchased items can be fulfilled. These counts can be incremented as new inventory becomes available, or is expected to become available, and decremented as purchased items are fulfilled. Each store maintains counts for its own inventory, and can provide program interfaces to allow other stores to affect its inventory counts.

Once a product's inventory properties are identified based on the inventory item resource, the product inventory counts are determined based on those properties. If the properties state that inventory is not tracked, then the available inventory count is considered to be infinite. However, if the properties state that inventory is tracked, the store's business logic searches for available or expected inventory by first examining its own inventory counts, and then examining the inventory counts, in sequence, of each of the stores in its inventory tracking storepath until sufficient available or expected inventory is found.

If no single store has enough inventory for the purchased item, then the store's business logic will allocate inventory from two or more stores. For example, suppose a store has 20 units of an item, the first store in its inventory tracking storepath has 30, and the last store in its storepath has 80. Each store may have its own business logic implementing its own business priorities. Thus a store's business logic, in order to use its own inventory first, might allocate 100 items in total by allocating 20 from its own inventory, 30 from the first profile store in its inventory tracking storepath, and the remaining 50 from the last profile store in its storepath. Alternatively, the store's business logic might allocate none from its own inventory, 30 from the first profile store, and 70 from the last profile store, in order to minimize the number of stores from which inventory is allocated.

A store inventory tracking administrator is responsible for recording inventory counts for that store as inventory becomes available or expected, but not for recording inventory counts for the stores in its inventory tracking storepath.

Pricing. Pricing represents the price range for a catalog entry and any criteria that must be satisfied in order to use that price. Prices can be defined with a shared master catalog, so if a price is not available in a store, then the price from the profile store can be used. If a individual store has a price, then it overrides the price from the profile store.

Tax Calculation. Different taxation rules may be defined for different jurisdictions, including sales tax, and other business or government taxes. A calculation code (i.e., “calcode” in FIG. 4) is associated with order items, catalog entries, or catalog groups to specify how discounts, shipping charges, sales or use taxes, and shipping taxes should be calculated. A calculation code defines how a calculation will be performed. Each calculation code contains a set of calculation rules. In general, only a subset of a calculation code's calculation rules are applicable for a particular set of order items. For example, different rules apply when shipping to different regions. A calculation scale is a set of ranges that can be used by a calculation rule. For example, for shipping charges, a set of weight ranges that each correspond to a particular cost may exist. That is, a product that weighs up to 5 kg might cost $10.00 to ship, while a product weighing over 5 kg and up to 10 kg might cost $15.00 to ship. A common set of calculation rules, codes and scales can be defined and shared by multiple stores.

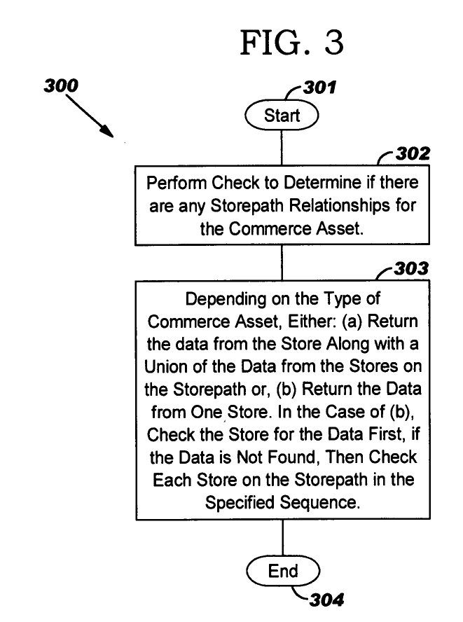

FIG. 3 is a flow chart illustrating operations 300 of modules within an electronic commerce server 110 for providing commerce asset information, including product catalog information, in accordance with an embodiment of the invention. A store defines a set of storepath relationships with other stores for a particular commerce asset (e.g., product catalog). Each relationship has a sequence number to prioritize the search order along the storepath if a store has multiple relationships for the same commerce asset. The following steps are followed to provide data for a particular commerce asset for a store. At step 301, the operations 300 start, typically upon receiving a query submitted by a customer to the sever 110 or generated internally by the server 110. At step 302, a check is performed to determine if there are any storepath relationships for the commerce asset. At step 303, depending on the type of commerce asset, as defined below, either: (a) the data from the store along with a union of the data from the stores on the storepath is returned; or, (b) the data from one store is returned. In the case of (b), the store is checked for the data first, if the data is not found, then each store on the storepath is checked in the specified sequence. At step 304, operations 300 end.

With respect to step 303, for each commerce asset type, the operations 300 of the module are as follows:

1. Catalog. The data returned includes: Catalog, Category, and Product. The data returned is a union of all the stores along the storepath. If the data is from the user's own store, then the user can edit the data. If the data if from a store along the storepath, and the user is not the owner of the data, then the user can only view the data, and the user cannot edit it.

2. Presentation. The data returned includes: View (JSP). The data returned is from one store, the first one along the store path. A store can override the data that is in a profile store.

3. Marketing. The data returned includes: Marketing Campaign, Initiative, and Customer Profile. The data returned is a union of all the stores along the storepath. If the data is from the user's own store, then the user can edit the data. If the data if from a store along the storepath, and the user is not the owner of the data, then the user can only view the data, and the user cannot edit it.

4. Business Logic. The data returned includes: Command. The data returned is from one store, the first one along the store path. A store can override the data that is in a profile store.

5. Business Policies. The data returned includes: Business Policy. The data returned is a union of all the stores along the storepath. If the data is from the user's own store, then the user can edit the data. If the data if from a store along the storepath, and the user is not the owner of the data, then the user can only view the data, and the user cannot edit it.

6. Inventory Item. The data returned includes: Product Properties related to Inventory. The data returned is from one store, the first one along the store path. A store can override the data that is in a profile store.

7. Inventory Tracking. The data returned includes: Product Inventory Count. The data returned is from one store, the first one along the store path. A store can override the data that is in a profile store.

8. Price. The data returned includes: Product Price. The data returned is from one store, the first one along the store path. A store can override the data that is in a profile store.

9. Tax Calculation. The data returned includes: Calculation Rules, Calculation Codes, and Calculation Scales. The data returned is from one store, the first one along the store path. A store can override the data that is in a profile store.

While this invention is primarily discussed as a method, a person of ordinary skill in the art understands that the apparatus discussed above with reference to a computer-implemented e-commerce server and system may be programmed or configured to enable the practice of the method of the invention. Moreover, an article of manufacture for use with a data processing system, such as a pre-recorded storage device or other similar computer readable medium including program instructions recorded thereon may direct the data processing system (see FIG. 5) to facilitate the practice of the method of the invention. It is understood that such apparatus and articles of manufacture also come within the scope of the invention.

Referring first to FIG. 5, an example is shown of a data processing system *00 which may be used for the invention. The system has a central processing unit (CPU) 510, which is coupled to various other components by system bus 512. Read only memory (“ROM”) 516 is coupled to the system bus 512 and includes a basic input/output system (“BIOS”) that controls certain basic functions of the data processing system 500. Random access memory (“RAM”) 514, I/O adapter 518, and communications adapter 534 are also coupled to the system bus 512. I/O adapter 518 may be a small computer system interface (“SCSI”) adapter that communicates with a disk storage device 520. Communications adapter 534 interconnects bus 512 with an outside network enabling the data processing system to communicate with other such systems. Input/Output devices are also connected to system bus 512 via user interface adapter 522 and display adapter 536. Keyboard 524, track ball 532, mouse 526 and speaker 528 are all interconnected to bus 512 via user interface adapter 522. Display monitor 538 is connected to system bus 512 by display adapter 536. In this manner, a user is capable of inputting to the system throughout the keyboard 524, trackball 532 or mouse 526 and receiving output from the system via speaker 528 and display 538.

Implementations of the invention include implementations as a computer system programmed to execute the method or methods described herein, and as a computer program product. According to the computer system implementation, sets of instructions for executing the method or methods may be resident in the random access memory 514 of one or more computer systems configured generally as described above. Until required by the computer system, the set of instructions may be stored as a computer program product in another computer memory, for example, in disk drive 520 (which may include a removable memory such as an optical disk or floppy disk for eventual use in the disk drive 520). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

1. A method for providing catalog information for presentation to a user of a store in an electronic commerce system, comprising the steps of:
storing a first portion and at least one second portion of said catalog information in said store and in at least one profile store, respectively, to share said at least one second portion of said catalog information between said store and at least one second store; and
storing path information defining a sequential relationship between said store and said at least one profile store for retrieving said catalog information for said store.

2. The method of claim 1, further comprising the steps of:
receiving a request for said catalog information from said user of said store;
determining from said path information in which of said at least one profile store said at least one second portion of said catalog information is stored; and
in response to said receiving and determining, retrieving said catalog information to fulfill said request.

3. The method of claim 2, wherein said retrieving comprises retrieving a union of said first portion and said at least one second portion of said catalog information sequentially from said store and said at least one profile store.

4. The method of claim 1, wherein said first portion and said at least one second portion of said catalog information have respective access restrictions.

5. The method of claim 4, wherein said access restrictions are editing restrictions.

6. The method of claim 1, wherein said catalog information includes items and said items include products and product categories.

7. The method of claim 6, wherein said catalog information includes product pricing and product description information for said products and product categories.

8. An electronic commerce server system for providing catalog information for presentation to a user of a store, said server system comprising:
a database for storing: (a) a first portion and at least one second portion of said catalog information in said store and in at least one profile store, respectively, to share said at least one second portion of said catalog information between said store and at least one second store; and (b) path information defining a sequential relationship between said store and said at least one profile store for retrieving said catalog information for said store.

9. The electronic commerce server system of claim 8, further comprising:
a database management system for: (a) receiving a request for said catalog information from said user of said store; (b) determining from said path information in which of said at least one profile store said at least one second portion of said catalog information is stored; and (c) in response to said receiving and determining, retrieving said catalog information to fulfill said request.

10. The electronic commerce server system of claim 9, wherein said database management system is adapted to retrieve a union of said first portion and said at least one second portion of said catalog information sequentially from said store and said at least one profile store.

11. The electronic commerce server system of claim 8, wherein said first portion and said at least one second portion of said catalog information have respective access restrictions.

12. The electronic commerce server system of claim 11, wherein said access restrictions are editing restrictions.

13. The electronic commerce server system of claim 8, wherein said catalog information includes items and said items include products and product categories.

14. The electronic commerce server system of claim 13, wherein said catalog information includes product pricing and product description information for said products and product categories.

15. A computer program product having a computer readable medium tangibly embodying computer executable code for directing an electronic commerce system to provide catalog information for presentation to a user of a store, said product comprising:
code for storing a first portion and at least one second portion of said catalog information in said store and in at least one profile store, respectively, to share said at least one second portion of said catalog information between said store and at least one second store; and
code for storing path information defining a sequential relationship between said store and said at least one profile store for retrieving said catalog information for said store.

16. The computer program product of claim 15, further comprising:
code for receiving a request for said catalog information from said user of said store;
code for determining from said path information in which of said at least one profile store said at least one second portion of said catalog information is stored; and,
code for retrieving said catalog information to fulfill said request in response to said code for receiving and determining.

17. The computer program product of claim 16, wherein said code for retrieving comprises code for retrieving a union of said first portion and said at least one second portion of said catalog information sequentially from said store and said at least one profile store.

18. The computer program product of claim 15, wherein said first portion and said at least one second portion of said catalog information have respective access restrictions.

19. The computer program product of claim 18, wherein said access restrictions are editing restrictions.

20. The computer program product of claim 15, wherein said catalog information includes items and said items include products and product categories.
